(19) United States
(12) Patent Application Publication
(10) Pub. No.: US 2013/0117087 A1
(43) Pub. Date: May 9, 2013

(54) SYSTEM AND METHOD FOR AUTHENTICATING ELECTRONIC TRANSACTION INSTRUMENTS

(71) Applicant: Paul D. Coppinger, Phoenix, AZ (US)

(72) Inventor: Paul D. Coppinger, Phoenix, AZ (US)

(73) Assignee: APRIVA, LLC, Scottsdale, AZ (US)

(21) Appl. No.: 13/290,759

(22) Filed: Nov. 7, 2011

(51) Int. Cl. G06Q 30/02

(52) U.S. Cl. 705/14.26; 705/14.27; 705/26.1

(57) ABSTRACT

Security is provided to electronically performed transactions by authenticating transaction instruments (such as electronic coupons, electronic receipts and electronic vouchers such as electronic tickets) that are utilized by a customer in a transaction, such as by a participating customer in a loyalty program. In an electronic wallet application provided on a mobile communication device, for example, digital signatures are applied to verify the authenticity of such transaction instruments when communicated between the communication device and a gateway that effectuates such transactions and defines, manages, distributes, processes and/or applies the corresponding transaction instruments. Digital signatures may also be applied to verify the authenticity of transaction instruments and related data when communicated between the gateway and other entities or systems.

### FIELD OF THE INVENTION

The present invention relates generally to secure transactions and, more particularly, to authentication of transaction instruments in an electronic wallet environment.

### BACKGROUND

Electronic means are increasingly utilized to perform transactions such as payments for purchases, proof of eligibility for rewards such as through loyalty programs, and so forth. The performance of such transactions requires sensitive data to be transferred among various entities involved, and further requires that such entities may reliably presume that transaction instruments utilized are from legitimate and expected parties to the transaction. Furthermore, in the future such transactions will increasingly be performed via mobile communication devices, such as smart phones. Therefore, a need exists to ensure that transaction instruments utilized in electronic transactions are legitimate, including those utilized in transactions that are conducted using mobile communication devices.

### SUMMARY OF THE INVENTION

The present invention overcomes the limitations of the prior art by providing a method and system for authenticating transaction instruments utilized in electronic transactions. A transaction instrument may be, for example, an electronic coupon, an electronic receipt or an electronic voucher such as an electronic ticket. The transaction instrument may be utilized by a customer in a transaction, such as in the process of receiving a loyalty member benefit, redeeming an offer or coupon, making a payment, providing proof of purchase, applying a voucher, gaining entry to an event, and so forth.

In one embodiment of the invention, a transaction gateway authenticates a transaction instrument that is provided to a customer. The transaction gateway creates a digital signature based on transaction instrument data associated with the transaction instrument. The transaction gateway then provides both the transaction instrument data and the digital signature over a network to a computing device of the customer. The computing device then verifies the digital signature to confirm the authenticity of the transaction instrument.

In various embodiments of the invention, the computing device of the customer may be, for example, a personal computer, a personal digital assistant, or a mobile communication device such as a smart phone. The computing device may have an electronic wallet software application which interfaces with the transaction gateway to accomplish various functions. In one embodiment, the customer may be a participating customer in a loyalty program and the transaction gateway may correspondingly be a loyalty gateway which interfaces with a loyalty wallet application on the customer's computing device to manage the customer's utilization of the loyalty program. The computing device may, such as via the wallet application, accept a transaction instrument only if the corresponding digital signature is verified and reject the transaction instrument otherwise, thereby determining, for example, whether it can be utilized by the transaction gateway thereafter in the performance of an associated transaction. The transaction gateway may thereafter obtain indicia from the computing device that the digital signature was verified to confirm legitimacy of the transaction instrument.

In applications of various embodiments, digital signatures may be applied to authenticate transaction instruments and related data that is communicated between various entities in a system that accomplishes associated transactions. Such entities may include a computing device such as a mobile communication device of the customer, a loyalty gateway interfacing with the computing device to manage the customer's use of the loyalty program, a payment gateway interfacing with a computing device of the customer (such as directly or via the loyalty gateway) to manage payments made by the customer, a point of sale system of a merchant through which such a transaction is executed, a computer system of a merchant that interacts with the loyalty gateway to effectuate management of the loyalty program for that merchant, and other entities such as, for example, business entities wishing to provide marketing information to customers via the system.

As an example, electronic coupon data associated with an electronic coupon may be signed when provided by a transaction gateway to a customer computing device having a wallet application that only accepts the coupon if it can verify the digital signature. As another example, electronic coupon data might be signed by the customer computing device when provided to the transaction gateway for redemption, or by a merchant computer system of a merchant when initially defining an electronic coupon and providing it to the transaction gateway. As still another example, electronic receipt data corresponding to an electronic receipt may similarly be signed when provided by the gateway to the customer computing device or when provided by the customer computing device to the transaction gateway or other entity for proof of authenticity. As yet another example, electronic ticket data corresponding to an electronic ticket may be signed by the transaction gateway or by the customer computing device in similar fashion.

### BRIEF DESCRIPTION OF EXEMPLARY DRAWINGS

A more complete understanding of the present invention may be derived by referring to the detailed description and claims when considered in connection with the Figures, wherein like reference numbers refer to similar elements throughout the Figures, and:

FIG. 1 is a system diagram illustrating system components for automatically enrolling and participating in a merchant loyalty campaign in accordance with an exemplary embodiment of the present invention;

FIG. 2 is a flow diagram illustrating an automatic enrollment process in accordance with an exemplary embodiment of the present invention; and

FIG. 3 is a flow diagram illustrating a payment transaction in accordance with an exemplary embodiment of the present invention.

### DETAILED DESCRIPTION OF EXEMPLARY EMBODIMENTS

In one embodiment of the invention, digital signatures are applied to transaction instruments utilized in a system that implements a loyalty program. Such a system may enable a mobile communication device to host an interface to a remote loyalty campaign processing and data storage system through, for example, a loyalty wallet software application installed on the mobile communication device. Loyalty campaigns are marketing campaigns that are designed to reward, and therefore encourage, loyal buying behavior. While the desire to build a base of loyal customers has existed for as long as commerce itself, structured programs designed to reward customers over a period of time and/or a number of purchases is a more recent innovation.

The marketing value of loyalty campaign participation is viewed as extending beyond simply attracting previous customers to repeat business with the merchant. Many of the loyalty campaign providers request or require a minimal amount of identifying information and demographic data from the participant. This information has been a valuable tool used by marketers to design highly targeted marketing campaigns that will produce optimal returns on marketing budgets.

Information provided by the customer during loyalty campaign enrollment may be used for various other purposes to the benefit of the customer and/or merchant. For example, where a customer has provided sufficient identifying information, the loyalty card may also be used to access such information to expedite verification during receipt of checks or dispensing of medical prescription preparations, or for other membership privileges (e.g., access to a club lounge in airports, using a frequent flyer card).

Conventionally, a loyalty campaign has involved the issuance of a plastic or paper card, visually similar to a credit card, which identifies the card holder as a member in a loyalty campaign. Modern technological innovations, however, will allow for such a card to be represented electronically on a mobile communications device that hosts an interface to a remote loyalty gateway that effectuates loyalty campaigns for potentially numerous merchants. Such a system is described in U.S. patent application Ser. No. 12/977,866, entitled “System and Device for Facilitating Mobile Enrollment and Participation in a Loyalty Campaign” and filed on Dec. 23, 2010, which is commonly assigned and which is hereby incorporated by reference.

In one embodiment, the interface to the loyalty campaign hosted by the communication device provides access to the variously disclosed features by way of a loyalty gateway, which itself receives and sends customer related information via a payment gateway and/or wireless network. Specifically, the invention includes a device and system for processing and storing information relating to customer transaction instruments, communication devices, purchases, loyalty campaign participation, merchant information, and loyalty campaign parameters.

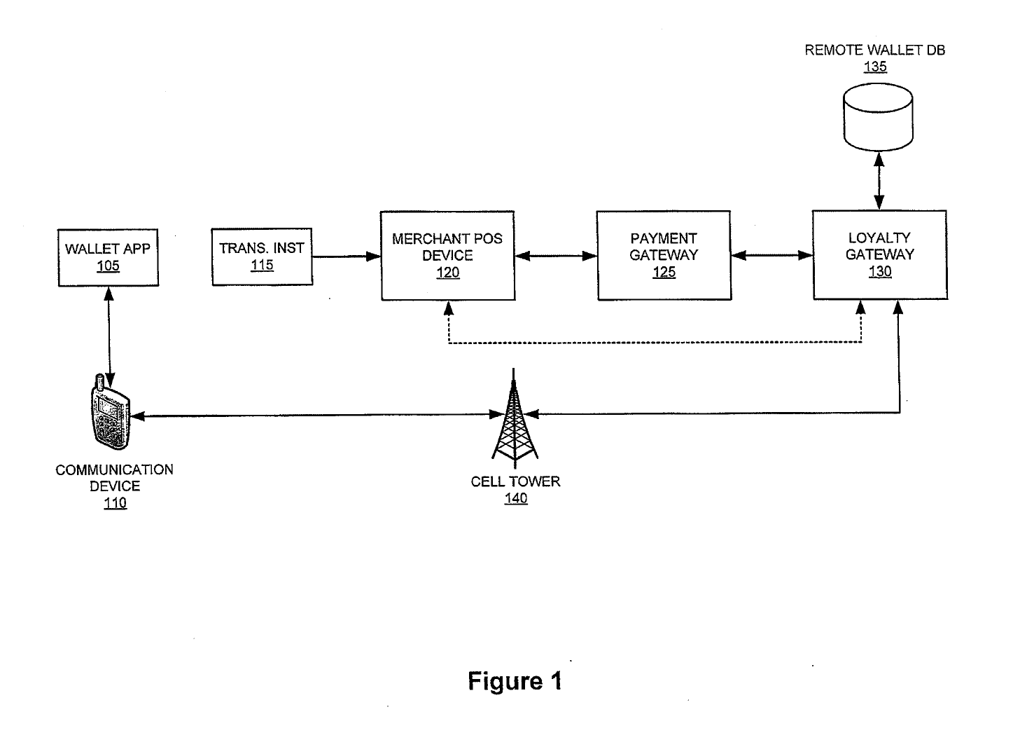

With reference to FIG. 1, the device and system includes a communication device 110 (i.e., mobile phone), which is used by a customer to access and perform the disclosed functions for enrolling and participating in merchant loyalty campaigns. The disclosed communication device 110 includes a wallet application 105, which provides, via a network 140, an interface to a loyalty gateway 130 for facilitating origination, transmission, and receipt of wallet data that is maintained at the loyalty gateway 130. In one embodiment, the wallet application 105 adds a secondary security layer to the base security architecture of a commercially available communication device 110.

In another embodiment, the loyalty gateway 130 serves as the primary intercept point for transactions originating at a POS device 120 or any other entity that compiles and sends a transaction authorization request. Accordingly, the loyalty gateway 130 receives transaction information in the form of an authorization request, extracts data needed to facilitate loyalty features, and routes the authorization request to an appropriate payment gateway 125 for transaction authorization. When the payment gateway 125 has processed the transaction request, an authorization response is sent back to the loyalty gateway 130 where any number of functions can be performed on the message in accordance with any applicable loyalty features as disclosed herein. Finally, the authorization response is sent from the loyalty gateway to the POS device 120.

While various embodiments for processing transaction requests are presented herein in accordance with the disclosed loyalty features, practitioners will appreciate that the ordering of routing and processing steps are presented for explanation only and are not intended to limit the scope of the invention. The variously disclosed processing and transmission steps may be performed by any number of computing devices or may be performed by a combination of devices, for example, and in varying orders. For example, the loyalty gateway 130 may modify a transaction authorization request based on loyalty information prior to passing the request to the payment gateway 125. In another example, the loyalty gateway 130 may not modify the authorization request, but instead modify the authorization response received from the payment gateway 125 based on the loyalty information.

As used herein, a “communication device” may comprise any hardware, software, or combination thereof configured to send, receive, process and store information in digital form for the purpose of invoking and managing the disclosed payment and loyalty transactions. More specifically, the communication device 110 may be embodied as any combination of hardware and/or software components configured to interact with various other hardware and/or software components to provide the disclosed loyalty campaign enrollment and wallet features.

It should be noted that although the present invention is described with respect to a communication device 110, the invention is not so limited. The invention is suitable for any device or instrument capable of storing distinct data sets, which may be provided by multiple distinct entities where the distinct data sets may be formatted, one different from another. The data sets may correspond to an account comprising, for example, a calling card, a loyalty, debit, credit, incentive, direct debit, savings, financial, membership account or the like. While the information provided by the account issuers may be described as being “owned” by the issuers, the issuers or their designees may simply be a manager of the account.

The communications device 110 and, more specifically, the wallet application 105 includes an interface that enables the customer to enroll in a merchant loyalty campaign, receive an offer from a merchant, accept an offer by entering a redemption code, receive and view information relating to a transaction, add transaction instruments to a remote wallet database 135, manage transaction instruments, manage offers and coupons from a plurality of merchants, and the like.

As used herein, the terms “customer”, “consumer”, “user,” “end user,” “cardholder”, “accountholder”, or “participant” may be used interchangeably with each other, and each shall mean any person, entity, machine, hardware, software, and/or business. Furthermore, the terms “business” or “merchant” may be used interchangeably with each other and shall mean any person, entity, machine, hardware, software, or business. Further still, the merchant may be any person, entity, software, and/or hardware that is a provider, broker, and/or any other entity in the distribution chain of goods or services.

The disclosed device and system provides real-time customer access to loyalty campaign enrollment, program participation, transaction instrument management, electronic receipts, electronic coupons, and any of the other features disclosed herein. In one embodiment, the communication device 110 shares information with the loyalty gateway 130 by way of a wireless communication network. The wallet application 105 may interact directly or indirectly with various components of the device and system to receive, process, store, and/or send information over the communications network.

Communication between various entities of the invention is accomplished through any suitable communication means, such as, for example, a telephone network, intranet, Internet, payment network (point-of-sale device, personal digital assistant, cellular phone, smart phone, appliance, kiosk, etc.), online communications, off-line communications, wireless communications, and/or the like. One skilled in the art will also appreciate that, for security reasons, any databases, systems, or components of the present invention may consist of any combination of databases or components at a single location or at multiple locations, wherein each database or system includes any of various suitable security features, such as firewalls, access codes, encryption, decryption, compression, decompression, and/or the like.

The transaction instrument 115 may be used to communicate to the merchant POS device 120 information from one or more data sets associated with the transaction instrument. This information may be encoded within the transaction device 115 and communicated to a merchant POS device 120 by way of, for example, reading a barcode, scanning a magnetic strip, manual key entry, voice entry, radio data transmission, infrared data signals, and the like. In one example, membership data and credit card data associated with a transaction account or device may be transmitted using any conventional protocol for transmission and/or retrieval of information from an account or associated transaction card (e.g., credit, debit, gift, stored value, loyalty, etc.). In another exemplary embodiment, a transaction instrument 115 may comprise an electronic coupon, voucher, and/or other such instrument. Moreover, the transaction instrument 115 may be used to pay for acquisitions, obtain access, provide identification, pay an amount, receive payment, redeem reward points, and/or the like.

In various exemplary embodiments, the transaction instrument 115 may be embodied in form factors other than, for example, a card-like structure. As described herein, the transaction instrument 115 and the communication device 110 may be one in the same, but not necessarily so. For example, account information that is conventionally read from a magnetic stripe of a credit card, may instead be maintained within the disclosed wallet application and transmitted to a gateway based on a user command issued to the communication device 110. In addition to a smart phone, the communication device 110 may comprise a typical Radio Frequency (RF) device, which may be implemented in a similar manner as is disclosed in U.S. application Ser. No. 12/553,901, entitled “System and Method for Facilitating Secure Voice Communication Over a Network”, which is commonly assigned, and which is incorporated herein by reference.

As used herein, loyalty campaign enrollment allows a customer to participate in various forms of incentive programs such as, for example, a merchant reward program. A loyalty campaign may include one or more loyalty accounts. Exemplary loyalty campaigns include frequent flyer miles, on-line points earned from viewing or purchasing products from websites, and programs associated with diner's cards, credit cards, debit cards, hotel cards, calling cards, and/or the like. Specifically, and within the context of the present invention, a loyalty campaign includes a distribution of coupons to a defined group of customers that participate with the invention to receive, manage, and redeem such coupons electronically.

Generally, the customer is both the owner of the transaction account and the participant in the loyalty campaign, however; this association is not necessary. For example, a participant in a loyalty campaign may gift loyalty points and/or coupons to a user who pays for a purchase with his own transaction account, but uses the gifted loyalty points instead of paying the monetary value. It is further contemplated, that where methodologies are used to group like customers into “households”, the owner of a transaction account used to facilitate a purchase transaction and the owner of a loyalty account may not me one in the same. For example, a child may receive benefit of her father's loyalty campaign participation while using her own credit card to facilitate a purchase from a merchant.

A “loyalty account number”, “code,” “account,” “account number,” “account code”, “identifier,” or “membership identifier,” as used herein, includes any device, code, or other identifier/indicia is suitably configured to allow a customer to interact or communicate with the disclosed system, such as, for example, authorization/access code, Personal Identification Number (PIN), Internet code, other identification code, and/or the like that is normally encoded within a SIM card, rewards card, charge card, credit card, debit card, prepaid card, telephone card, smart card, magnetic strip card, bar code card, radio frequency card and/or the like. However, in the context of the present invention, such information may be maintained at the loyalty gateway 130 or any other component capable of securely storing data such that sensitive account information may not be compromised if the communication device 110 becomes lost or stolen. A reference to the disparately stored account information may be maintained within and/or accessed from the memory portion of the disparately located communication device 110.

The account code may be distributed and stored in any form of plastic, electronic, magnetic, radio frequency, audio and/or optical device capable of transmitting or downloading data from itself to a second device. An account code may be, for example, a sixteen-digit credit card number, although each credit provider has its own numbering system, such as the fifteen-digit numbering system used by an exemplary loyalty system. Each company's credit card numbers comply with that company's standardized format such that the company using a sixteen-digit format may generally use four spaced sets of numbers, as represented by the number “0000 0000 0000 0000”. The first five to seven digits are reserved for processing purposes and identify the issuing bank, card type and etc. In this example, the last sixteenth digit is used as a sum check for the sixteen-digit number. The intermediary eight-to-ten digits are used to uniquely identify the customer. In addition, loyalty account numbers of various types may be used.

The “transaction information” in accordance with this invention may include the nature or amount of transaction, as well as, a merchant, customer, and/or issuer identifier, security codes, routing numbers, and the like. In various exemplary embodiments of the invention, one or more transaction accounts may be used to satisfy or complete a transaction. For example, the transaction may be only partially completed using the transaction account(s) correlating to the application tenant information stored on the transaction device with the balance of the transaction being completed using other sources. Cash may be used to complete part of a transaction and the transaction account associated with a user and the transaction device, may be used to satisfy the balance of the transaction. Alternatively, the user may identify which transaction account, or combination of transaction accounts, stored on the transaction device the user desires to complete the transaction. Any presently known or future methods and/or systems configured to manipulate the transaction information for transport and/or processing over a network may be implemented without departing from the scope of the invention.

One skilled in the art will appreciate that a network may include any system for exchanging data or transacting business, such as the Internet, an intranet, an extranet, WAN, LAN, satellite communications, cellular network, and/or the like. It is noted that the network may be implemented as other types of networks such as, for example, an interactive television (ITV) network. The users may interact with the system via any input device such as a keyboard, mouse, kiosk, personal digital assistant, handheld computer, cellular phone, smart phone, and/or the like. Similarly, the features of the invention may be used in conjunction with any type of personal computer, network computer, workstation, minicomputer, mainframe, or the like running any operating system such as any version of Windows, Windows XP, Windows Vista, Windows NT, Windows 2000, Windows 98, Windows 95, MacOS, OS/2, BeOS, Linux, UNIX, Solaris, or the like. Moreover, although the invention is frequently described herein as being implemented with specific communications protocols, it may be readily understood that the invention could also be implemented using IPX, AppleTalk, IP-6, NetBIOS, OSI or any number of existing or future protocols. Moreover, the system may contemplate the use, sale or distribution of any goods, services or information over any network having similar functionality described herein.

The security layer of the wallet application 105 includes a security interface for collecting user credentials. As used herein, the “security interface” comprises any hardware, software, or combination thereof, which is configured to accept an input by any of the parties described herein. An “input” may be defined as, for example, key presses on a physical keyboard, button selection on a touch screen, a verbal command, a biometric sample read, and the like. Inputs may include, for example, a fingerprint, voiceprint, iris scan, facial feature recognition, and the like. However, practitioners will appreciate that entry of a PIN, or any other indicia described herein, may be performed by any means known in the art.

In one embodiment, for example, a communication device 110 comprising a smart phone may be used by an account holder to speak a pass phrase. The pass phrase is converted to a digital representation and interpreted by way of voice recognition. Voice recognition, as used herein, refers to systems and processes that translate the spoken word into a specific response. Voice recognition systems are configured to understand the spoken word, not to establish the identity of the user. An example of a voice recognition system is that of an automated call center wherein a user is prompted to press a number on the phone keypad or speak a command to select a menu item.

In another embodiment, the communication device 110 or any other component of the invention, may invoke voice verification in order to match the voice pattern of the speaker to a stored voice print. Voice verification, as used herein, refers to systems and processes that verify the vocal characteristics of a voice sample against those associated with an enrolled user. The voice verification system may use pattern-matching technologies to determine whether a sample voiceprint matches that of a stored voiceprint. Voice recognition, as used herein, refers to systems and processes that translate the spoken word into a specific response. Voice recognition systems are configured to understand the spoken word, not to establish the identity of the user. An example of a voice recognition system is that of an automated call center wherein a user is prompted to press a number on the phone keypad or speak a command to select a menu item.

Prior to using the voice authentication embodiment, the user may enroll and setup an account with a verification system. The verification system may reside as a standalone server that is geographically disparate from the components of the loyalty gateway 130 and may reside in embodiments comprising program code, specialized hardware components, or a combination thereof.

An existing user may be provided with a set of credentials especially configured to access the verification system, or may enter existing credentials that are readily used to access general account information at the loyalty gateway 130. For example, the customer may call a number to access a loyalty gateway primary automated menu and select or speak an option that switches the user's call to the verification system. When the customer's call is received at the verification system, the customer is directed to select or speak an option from the verification system menu. For example, a voice prompt may instruct the user to press 1 or say “one” to setup a voice ID account, press 2 or say “two” to modify one or more stored voice print models, or press 3 or say “three” to create a new stored voice print model.

Practitioners will appreciate that the following enrollment steps are presented for explanation only and does not necessarily represent various other embodiments of the invention as disclosed herein. Further, loyalty campaign enrollment process steps may be added, combined, and/or eliminated without departing from the scope of the invention. The following describes an exemplary enrollment process as may be facilitated, in part, through an incorporation of the wallet application 105 and the services it provides. However, those of ordinary skill will appreciate that the various functional elements of the wallet application 105 and loyalty gateway 130 may be provided through any combination of software and hardware components, which are suitable configured to facilitate a subset of the process steps disclosed herein.

When a customer presents a transaction instrument to a merchant to facilitate a payment transaction, the transaction information is read, formatted, and sent by the merchant POS device 120 to a payment gateway 125. As described herein, the transaction information may include various types of data that are used to identify the customer, merchant, transaction account, and settlement entity. For the purpose of explanation, it should be assumed that the transaction information includes, at a minimum, a transaction account identifier and a merchant identifier.

As used herein, a payment gateway 125 comprises any hardware, software, or combination thereof, which is configured to perform transaction instrument processing, billing, reporting and settlement. The payment gateway 125 further provides operational services to acquiring and issuing banks, manages the process of transferring authorized and captured transaction account funds between different financial accounts such as, for example, the merchants checking account. In an exemplary embodiment, the payment gateway 125 performs transaction authorization in the conventional manner and transmits the transaction information, or subset thereof, to the loyalty gateway 130.

In one embodiment, the loyalty gateway 130 determines whether a Mobile Device Number (MDN) is included in the transaction information. As used herein, a MDN is used to specifically identify the communication device 110; however, practitioners will appreciate that other identifiers may be used within the disclosed processes without departing from the scope of the invention. Additional identifiers may include, for example, device specific indicia such as a processor ID and SIM ID, or may comprise user specific indicia such as a driver license number.

When the loyalty gateway 130 determines that the transaction information does not include a MDN, then a query is invoked to search the remote wallet database 135 for wallet information corresponding to the transaction account identifier and second, the merchant identifier. When wallet data corresponding to first, the transaction account identifier and merchant identifier is located within the remote wallet database 135, then the MDN from the returned database record(s) is extracted; otherwise, the merchant is alerted via a response message to the merchant POS device 120 that the customer's transaction instrument 115 is not enrolled in the merchant's loyalty campaign. This provides the merchant with an opportunity to enroll the customer in the merchant's loyalty campaign. The enrollment process will be described in greater detail herein.

If the customer has not yet installed and configured the wallet application 105, the transaction instrument information is associated with the customer's MDN at the loyalty gateway 130. In response, the loyalty gateway 130 transmits a Short Message Service (SMS) message to the customer's communication device 110, which includes a link to an installation application for the native wallet application 105. In another embodiment, the customer may enroll via an enrollment code that is included on the consumer's electronic receipt that is received by way of SMS message to the customer's communication device 110.

Practitioners will appreciate that any number of methods may be implemented in order to encourage an enrolled customer to install the wallet application 105 to their communication device 110 such as, for example, by way of an email message, voice message, and the like, which may be retrieved by the customer from any known device. In one embodiment, the customer may receive and redeem a shareable coupon that is received by the customer from a second customer. For example, as an enrolled participant in Merchant A's loyalty program, Joe receives an electronic coupon for ten-percent off of his next purchase from Merchant A. Joe may forward the coupon via SMS to his friend, Beth. When Beth wishes to redeem the “gifted” coupon, the loyalty gateway 130 automatically enrolls Beth in the issuing merchant's loyalty campaign and allows her to install the wallet application 105 to her communication device 110.

There may be a circumstance when the customer presents a transaction instrument 115 at the merchant POS device 120 that has been used previously in transactions with other merchants; however, it has not been used at the present merchant. When this is the case, the loyalty gateway 130 searches for a wallet using the transaction instrument identifier (e.g., credit card number). If a wallet record corresponding to the transaction instrument identifier is located, then the associated MDN is retrieved from the wallet record. On determining that MDN is associated with another merchant's loyalty campaign, the loyalty gateway 130 updates the customer's wallet information to automatically enroll the customer into the present merchant's loyalty campaign. In another embodiment, the loyalty gateway 130 sends a SMS message with an offer to the customer's communication device 110. The customer may redeem the offer by responding to the SMS, which causes the loyalty gateway 130 to enroll the customer in the merchant's loyalty program.

When facilitating a payment transaction at a merchant, the customer's transaction instrument 115 is read or entered at the point of sale in the conventional manner. Depending on the type of transaction (e.g., in-store, online, phone-order), the transaction instrument 115 may be read or entered at a merchant POS device 120, personal computing device, or telephone. If the customer is enrolled in the merchant's loyalty campaign, an electronic purchase receipt is transmitted from the loyalty gateway 130 to the customer's communications device 110. The purchase receipt includes a summary of the transaction (e.g., item description, item price, applicable sales tax, purchase total) and an offer. The purchase receipt may further include a redemption code that is uniquely generated for the specific customer.

The redemption code may, for example, entitle the customer to a discount on a subsequent purchase of a similar item, a discount on a different item, a discount on an item or service provided by an associated merchant, a free item, a number of points to be credited to the customer's loyalty account, and the like. The customer may choose to save the receipt, offer, and/or redemption code for review or for later redemption. The customer may also redeem the offer to receive a discount for the current purchase. In one embodiment, the customer responds to a SMS message received at the communication device 110 from the loyalty gateway 130, with a return SMS message that includes the redemption code. A more detailed description of the enrollment and redemption processing steps as previously described are included below.

The transaction processing begins when the customer enters or swipes a transaction instrument at a POS device 120 or enters the information at a checkout web page. Transaction information including the transaction instrument identifier and merchant identifier is sent to the payment gateway 125 for presale processing. As described herein, the transaction information from the POS device 120 may first be sent to the loyalty gateway 130 or any other gateway, prior to being sent to the payment gateway 125. If the transaction information includes a MDN, then this is indicative that the customer provided their mobile number to the merchant at the point of sale.

As previously described, a MDN may be provided at the point of sale when a customer wishes to enroll in the merchant's loyalty campaign and has not previously enrolled with any other merchant. Nevertheless, the loyalty gateway 130 may search the wallet database 135 for the MDN to ensure that the customer had not previously enrolled. If the MDN is located, then stored records corresponding to the MDN may be used to enroll the customer in the current merchant's loyalty campaign. Otherwise, the transaction information, including the transaction instrument and merchant identifiers, are used to create a new wallet record, thereby enrolling the customer in the merchant's loyalty campaign.

Alternatively, if the merchant identifier is located and the transaction instrument identifier is not, then the loyalty gateway 130 performs a search to determine whether the customer's MDN corresponds to the merchant identifier. If this is the case, then the customer may have previously enrolled in the merchant's loyalty campaign using a different transaction instrument and the current transaction instrument is assumed to not have been previously used with the current merchant. As such, the loyalty gateway 130 adds the current transaction instrument identifier to the customer's wallet, thereby allowing future use of the transaction instrument for participation in the merchant's loyalty campaign.

More specifically, the loyalty gateway 130 is configured to determine when a parameter for an enrolled customer is different than the parameters stored in the wallet database 135 and update the customer's information to reflect such changes. For example, Beth previously purchased an item from Joe's Jewelers using her American Express credit card and enrolled in Joe's Jewelers' loyalty campaign by responding to an invitation from the merchant and/or merchant POS device 120. At the time of her enrollment, Beth's American Express account number was associated with her cell phone number. On a subsequent visit to Joe's Jewelers, Beth purchases another item using her Visa credit card. Because Beth's Visa credit card account number has not been associated with her wallet at the loyalty gateway 130, there is no way to identify Beth as a being enrolled in Joe's loyalty campaign other than by identifying her by her cell phone number. Therefore, Beth provides her cell phone number at Joe's Jewelers' POS device, the cell phone number is used by the loyalty gateway to identify Beth as an enrolled customer, and Beth's wallet is updated to include her previously absent Visa account information. When Beth makes subsequent purchases from Joe's using either her American Express or Visa credit cards, the loyalty gateway will identify Beth as an enrolled member without requiring her to provide her cell phone number.

When the transaction information received by the loyalty gateway 130 does not include a MDN, the transaction account and merchant identifiers are used to locate a record corresponding to the merchant and transaction instrument. If a record corresponding to the transaction instrument identifier is located but the merchant identifier is not, then the customer is assumed to be enrolled in another merchant's loyalty campaign. As a result, the transaction information is used to automatically enroll the customer in the current merchant's loyalty campaign.

In another embodiment, the customer may notify the merchant that they are enrolled in that merchant's loyalty campaign and provide the merchant with their enrolled MDN. This is useful, for example, when the customer is using cash, which cannot be used to draw an association with a customer's wallet. When the customer's MDN is entered at the merchant POS device 120, the MDN is transmitted to the loyalty gateway 130 with the transaction information where it is used to locate the customer's wallet information.

When the customer is enrolled in the merchant's loyalty campaign, the loyalty gateway 130 determines whether the subscribed loyalty campaign is in effect and whether the customer is entitled to receive and/or redeem a coupon for the present transaction. Those of ordinary skill in the art will appreciate that the disclosed loyalty gateway 130 may enable the merchant to specify parameters to be applied to any number of loyalty campaign schemes. In an effort to sell more Craftsman® tools, for example, the merchant may specify that loyalty campaign participants purchasing Craftsman tools are to be issued an instant coupon for 20% off of the tool's normal purchase price, while purchases of all other tools entitle participants to receive coupons for 10% off.

When an enrolled customer is eligible to receive a reward (i.e., coupon or offer), then the loyalty gateway 130 retrieves offer parameters and applies them to the transaction information. For example, if a coupon exists that entitles the customer to 10% off of their purchase; the loyalty gateway 130 deducts 10% off of the purchase price in the transaction information. When the transaction information has been modified, then it is sent to the payment gateway 125 to be processed in the conventional manner.

In one embodiment, the customer's purchase entitles the customer to a discount that might be applied to a future purchase. In this case, the loyalty gateway 130 retrieves coupon information and sends it to the customer's communication device. When received, the customer can view, store, or gift the coupon to another customer.

In another embodiment, the electronic coupon, which is sent to the communication device, serves as a token. More specifically, the electronic coupon includes electronic token information that allows the customer to be identified when the coupon is redeemed. Practitioners will appreciate that there are any number of data that may be included in the electronic coupon that may be used for any number of purposes. For example, redemption of a coupon may also serve as a secure payment means that facilitates a financial transaction without requiring presentment of a separate transaction instrument.

Several scenarios and examples have been provided to describe various methods for enrolling a customer into a merchant loyalty campaign. It is contemplated that in addition to the presented scenarios, other scenarios may require minor variations in the sequence of steps and/or the nature of the performed steps. For example, practitioners will appreciate that the invention may be implemented for varying types of purchase transactions including traditional purchases invoked within a merchant's storefront, online purchases from a merchant's website, telephone purchases, and the like.

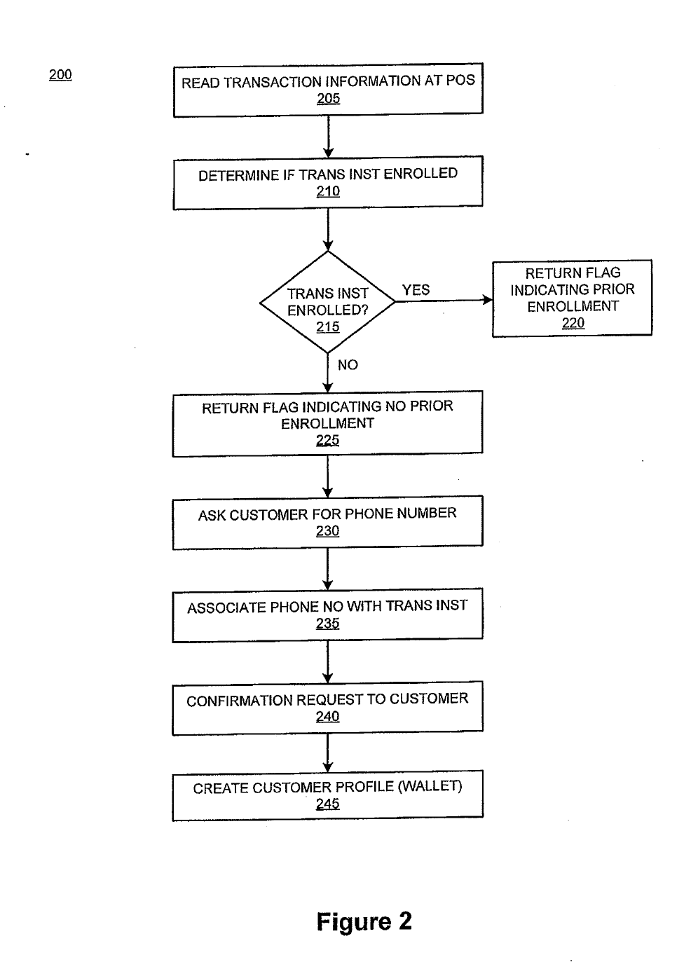

The above description provides an overview of the enrollment process, primarily from the perspective of the customer. Practitioners will appreciate that the benefits produced through the implementation of the disclosed system and device provides many benefits both to the consumer and to the merchant. The following description of FIG. 2 is intended to demonstrate an exemplary process flow for enrolling a customer into a loyalty campaign, in particular, as a merchant implemented loyalty campaign. However, practitioners will appreciate that the disclosed system and method is applicable to any number of disparate merchants as a holistic loyalty campaign solution, which may be implemented and administered through a third-party provider.

To provide merchants with the ability to cost-effectively offer their customers participation in a loyalty campaign, the disclosed device and system eliminates any need to issue a branded loyalty instrument (i.e., rewards card). Rather, the invention provides a seamless enrollment process using any issuer's transaction instrument (e.g., smart card, credit card, debit card, pre-paid card, etc.) as it is used through a normal transaction process. In other words, a transaction instrument with a unique Primary Account Number (PAN), for example, may serve as the loyalty instrument.

With reference to FIG. 2 and continued reference to FIG. 1, the enrollment process is invoked when a merchant reads a transaction instrument at a merchant POS device 110 and the transaction information is passed through a payment gateway 125 to a loyalty gateway (step 205). In another embodiment, the transaction information is sent from the merchant POS device 110 to the loyalty gateway 130. In addition to the processing steps described herein, the loyalty gateway 130 determines an appropriate payment gateway 125 based on the transaction information (or stored data corresponding to a subset of the transaction information), and sends an authorization request including the transaction information to the identified payment gateway 125 for authorization.

On receiving the transaction information from either the merchant POS device 110 or the payment gateway 125, the loyalty gateway 130 determines whether the read transaction instrument has been enrolled (step 210) in the merchant's loyalty campaign. If the loyalty gateway 130 determines that the transaction instrument has been enrolled (step 215), a flag is returned indicating that the transaction instrument has already been enrolled with either the present merchant or another merchant (step 220). When a communication device 110 has been previously enrolled by another merchant, the merchant POS device 120 displays a prompt to determine whether the customer would like to enroll with the present merchant as well. Alternatively, the customer may be automatically enrolled with the merchant without presenting a prompt.

If the loyalty gateway 130 determines that the transaction instrument has not been enrolled (step 215), a flag is returned back to the merchant POS device 120 indicating that the transaction instrument has not been enrolled (step 225). The merchant POS device 120 displays a prompt stating that this is a new customer and requesting the customer's communication device 110 identifier (i.e., phone number) (step 230).

In one embodiment, the merchant may bypass an enrollment prompt while facilitating anonymous enrollment of a communication device 110 (i.e., without a mobile number). To encourage participation by a merchant who routinely skips the prompt, the system may generate an exception report, which gives the provider information useful in educating the merchant on the benefits that loyalty campaign participation provides. It should be noted that data corresponding to anonymously enrolled transaction instruments may further provide analysis of consumer behavior and can help to build a business case to the merchant showing the value that might be realized through offering a loyalty campaign to its customers.

Anonymous enrollment also allows the merchant to encourage repeat buying from previous customers retroactively, even after deciding to implement a loyalty campaign. In other words, customers can be provided offers from the merchant based on purchases made prior to a loyalty campaign being made available to them from the merchant. Because the loyalty gateway 130 maintains information linking a MDN to a transaction instrument identifier, a customer who has previously enrolled with any other participating merchant can be identified. As such, when a merchant implements a new loyalty campaign through the loyalty gateway 130, anonymous records corresponding to past transactions can be linked to a customer's MDN, allowing coupons and/or offers to be sent to the customer's communication device 110 based on previous purchases.

The communication device 110 identifier (i.e., MDN) is sent to the loyalty gateway 130 and is associated with the customer's transaction instrument (step 235). The association may be flagged to denote that the address is “unconfirmed.” In one embodiment, a threshold number of “unconfirmed” associations may be set in order to create an exception that requires remediation with a merchant.

A message (i.e., SMS) is sent to the communication device 110 requesting the customer's confirmation of the association (step 240). An affirmative response from the customer, sent back to the loyalty gateway 130, changes the association state to “confirmed” and creates an initial (mostly empty) customer profile (step 245). If other transaction instruments have been associated with the communication device 110 identifier, then all the associated transaction instruments may share a common profile. As an anti-fraud measure, transaction instruments with significantly different names in the track data may not be linked together and the transaction instrument identifier may be flagged as potentially fraudulent. In such a case, remediation may be desirable.

The above describes an exemplary enrollment process, whereby merchants are able to encourage customer participation in a loyalty campaign without incurring the expenses associated with an addition to or modification of POS hardware. Other expenses relating to issuance of loyalty account instruments (i.e., loyalty card) and loyalty account maintenance are mitigated through an implementation of the above automatic enrollment process.

Moreover, due to the consolidation of the customer enrollment and participation processes by a single entity (i.e., the loyalty gateway), reporting features enable the provider to build a business case that is useful in encouraging merchant participation. For example, a provider may approach a merchant as follows: “Did you know that 70% of your revenue comes from the 10% of your customers that use you more than once each month? Imagine what would happen if you turned the other 90% into repeat customers.”

In accordance with one embodiment, the system includes a wallet interface that operates as a wallet application 105 at the user's communication device 110. As used herein, a “wallet” may comprise any hardware and/or software suitably configured to manage and store personal information within a memory structure of a computing device, including a loyalty gateway 130 and a remote communication device 110. The wallet application 105 includes various interface elements, which allow the user to configure and manage various system features as disclosed herein. These interface elements may be presented in the form of one or more progressive interfaces (i.e., wizard) that guide the customer through wallet application 105 installation and configuration. The various example wizard interfaces described below are presented for explanation only and are not intended to limit the scope of the invention. For example, while the term “wizard” is commonly used in the context of a series of visual screens, the processes described herein may be facilitated by way of audio prompts and verbal responses.

During wallet application 105 installation, or at any point following, the user is presented with a wizard interface from which to enter and/or modify personal account information. Practitioners will appreciate that any number of present and/or future known methods may be implemented in order to minimize manual data entry tasks. The system knows the name associated with a presented transaction instrument and can use that to search for the user in his “contacts” list. The personal information For example, when a phone number for the communication device 110 can be located, the contacts stored within that communication device 110 may be searched, thus enabling the wizard to pre-populate various fields from information that is associated with the phone number. Additional interface screens for entering and/or modifying personal information may include, for example, editable text boxes for entering a first name, middle name, last name, secondary phone number, mailing address, email address, credit card numbers, and the like. All, or a subset, of this information may be programmatically extracted and parsed from various memory regions within the communication device 110 or acquired from existing customer records stored in the remote wallet database 135.

Just as a “wallet” as conventionally known stores items containing sensitive information (e.g., driver license, social security card, credit cards, loyalty cards, access cards, photos, etc.); the wallet application 105 disclosed herein likewise facilitates storage of sensitive and private information that should be inaccessible by unauthorized individuals. As such, the wallet application 105 is managed by a security component, which may incorporate any number of security schemes configured to manage user permissions and restrict access from unauthorized users.

Accordingly, when an installation and configuration process is instantiated, the customer may be prompted to enter a Personal Identification Number (PIN), for example, that is to be used to authenticate the customer in order to invoke subsequent tasks and/or transactions. Practitioners will appreciate that the invention may implement any known method for performing user authentication including for example, PIN or password entry, voice sampling, iris scanning, finger printing, and the like. Nevertheless, the user is prompted to provide a secret code and/or biometric sample, which is stored within a remote data store and keyed by a unique identifier of the communication device.

During wallet application 105 installation, the customer is provided with an option to cancel the installation and configuration process. Canceling this process causes the data that has been entered up to the moment of cancellation to be stored in a temporary memory location within the communication device 110 or at the remote wallet database 135. This enables the installation and configuration process to be resumed at a later time, without requiring the customer to reenter the information that had already been provided. When the wallet application installation remains incomplete (i.e., installation was interrupted prior to completion), the customer may be prompted at defined intervals (e.g., every two days) alerting that wallet application installation and configuration was not completed and allowing the customer to opt to resume wallet installation and configuration at the point that it was previously interrupted.

The wallet application installation and configuration process further allows the customer to enter transaction instrument 115 information for storage and subsequent retrieval. Accordingly, the user may be presented with an interface displaying an empty or partially populated list of transaction instruments along with an interface button that may be selected when the user wishes to provide information relating to additional transaction instruments.

The wallet application 105 provides various interfaces that reside between the customer and the loyalty gateway 130. A subset of these interfaces allows the customer to populate their wallet with transaction instrument 115 information. In one embodiment, to add a transaction instrument 115 by way of the wallet application 105, the customer is presented with an interface that includes, for example, a list of credit card types (e:g., Visa, MasterCard, American Express, Discover, etc.), an edit box for card number entry, a date selector for the expiration date, and an edit box for entry of a Card Verification Code (CVC). Moreover, when the transaction instrument 115 is a debit card, a field is provided for entry of the debit card PIN. If the customer elects to save the entered information, the transaction instrument information is transmitted to the loyalty gateway 130 via secured socket connection, for example, where it is stored in the remote wallet database 135.

In addition to allowing the customer to add transaction instrument information through the disclosed wallet application, the invention provides a means for entering other information relating to other types of transaction accounts that may, or may not, have an associated transaction instrument (e.g., a bank checking account). For example, the customer may choose to pay for a service by way of an electronic check, rather than by a debit or credit card. As such, a wallet interface of the wallet application 105 may include fields for entering a bank routing number and a bank account number. Moreover, practitioners will appreciate that other types of account information may be entered for wallet storage including, for example, loyalty account information, a Social Security Number, a driver license number, secure access codes, membership information, and the like.

As described herein, the invention provides efficient enrollment of customers to a merchant loyalty campaign without requiring the merchant to issue loyalty cards to those customers. However, there may be scenarios where it would be desirable for a customer to be able to manually add a loyalty card to their wallet application 105. For example, a customer may have previously acquired a number of loyalty cards from various merchants prior to enrolling in a merchant loyalty campaign using the disclosed automatic enrollment process. Therefore, the customer may access an interface of the wallet application 105, which includes editable fields for entering the loyalty card name, loyalty account number, and any other relevant information to be stored.

Information entered and/or modified within the interface fields may be added to the customer's wallet records, which in one embodiment, are stored in the remote wallet database 135. As such, the customer may be presented with options (i.e., buttons) to save or reject the customer-entered additions. An election to save the information causes the wallet application 105 at the communication device 110 to transmit the data to the loyalty gateway 130 where the data is processed and saved to the remote wallet database 135.

In addition to providing the previously described features, the wallet application 115 operating at the communications device 110 allows the customer to manage information that is maintained at the remote wallet database 135. This information is assumed to be private in nature; however, methods for managing, processing, and storing other types of less-sensitive information are contemplated.

To allow the customer to modify personal account information, the customer invokes the wallet application 105. The wallet application security layer is made active, prompting the customer to enter an authentication credential. As described herein, an authentication credential may comprise a code and/or biometric sample that are verified against a stored code or a stored biometric sample. For explanation, an authentication credential is used herein as comprising a PIN.

The wallet application 105 sends the PIN and MDN to the loyalty gateway 130. Upon successful verification of the PIN, the wallet application 105 presents the customer with a screen (interface) that includes interface buttons that may be selected to access general account information, transaction instruments, and transaction records. Based on the customer's selection, the wallet application 115 presents one or more interfaces that include the related information, and where appropriate, provides the customer an ability to modify the information. For example, a customer selecting an “Account Information” interface button is presented with an interface screen that includes fields for first name, middle name, last name, phone number, and email address. The “Account Information” interface may itself include interface buttons that invoke views of billing information, shipping information, and a screen to modify authentication credentials (e.g., PIN).

Those of ordinary skill in the art will appreciate that the specific arrangement of the various interface screens and user interface elements, presented herein by way of example, are intended for explanation only and do not limit the scope of the invention. In one embodiment, for example, all information relating to “Billing Information” may be displayed in a single scrolling interface screen. In another embodiment, fields relating to “Billing Information” may be divided into a number of screens, grouping similar information among each screen.

Similar to what has been described above, the invention allows a user to modify other types of information in order to manage the records that are maintained within the remote wallet database 135. In one embodiment, a loyalty gateway 130 administrator defines policies governing which information may be added, modified, or deleted by a user. Transaction instrument types that are accessible by the customer and would typically be modifiable include, for example, transaction instrument, credit card, debit card, bank account, and loyalty card. In another embodiment, the customer may also store scanned images of items such as a driver license, membership card, Social Security card, employee badge, and access card.

As described herein, the wallet application 105 provides a number of interfaces that allow the customer to search, view, and enroll in loyalty campaigns. The interface also allows the customer to review their wallet contents. Similar to a conventional wallet, the wallet application 105 helps the customer organize and maintain various transaction instruments, loyalty cards, access cards, membership cards, identity cards, and the like. However, the wallet application 105 also includes various features that assist the customer in facilitating loyalty account management including enrollment, monitoring, and redemption. The following describes features of the invention that are directed toward the execution of purchase transactions in relation to loyalty campaign participation.

The “pending transactions” interface provides an interface button that allows the customer to optionally change payment information. The change payment information interface screen allows the customer to select a transaction instrument to run the payment transaction against. For example, a customer at a merchant POS device 120 hands the merchant his MasterCard credit card and the transaction information is submitted to the loyalty gateway 130 via the payment gateway 125. The transaction instrument identifier is used by the loyalty gateway 130 to identify the customer and retrieve the phone number for the customer's communication device 110. As described above, the loyalty gateway 130 sends a push notification or SMS, invoking an alert notifying the customer of the pending transaction. While viewing the pending transactions interface, the customer selects the “change payment information” button and is presented with an interface listing each of the transaction instruments that have previously been added to the customer's wallet. The customer selects his Discover Card transaction instrument and an updated pending transactions interface reflects the change. The customer selects the “accept transaction” interface button causing the transaction information to be sent to the payment gateway 125 as an authorization request.

In one embodiment, the customer may interact with the loyalty gateway 130 via the communication device 110 to select an offer that has not necessarily been solicited. Accordingly, the customer invokes the wallet application 105 to retrieve and view a number of merchants offering enrollment in loyalty campaigns. The customer may limit a list of merchants by merchant type, product/service type, geographical region, price range, and the like.

The customer may further select a merchant from a list of merchants returned by the loyalty gateway 130 and enroll in the selected merchant's loyalty campaign. Manual enrollment may include requiring the customer to enter information that is used at the loyalty gateway 130 to create/update records corresponding to the specific customer. In another embodiment, all or a subset of, the enrollment information is acquired from stored customer information such that manual entry is minimized or eliminated. It should be appreciated that “enrollment information” may include any number of individual data items such as, for example, first name, last name, mailing address, city, state, postal code, email address, credit card name, credit card number, expiration date, CVC code, and etc. Enrollment information may be entered into fields provided by a wallet application 105 interface, automatically submitted from a stored customer profile, acquired from a third-party source, or any combination thereof.

The customer may interact with the wallet application 105 in order to perform a number of additional tasks including, for example, viewing a loyalty account point balance, viewing acquired coupons, viewing cumulative savings, viewing transaction summaries, searching for promotions, and the like. The customer may also select point promotions that are available based on the customer's balance of loyalty points. In one embodiment, the customer may select to redeem a point balance toward a future purchase. The loyalty gateway 130 is notified of the request to redeem a balance of points and a pending redemption is recorded. When executing the subsequent purchase transaction, the pending points are automatically redeemed and the monetary value of the redemption is deducted from the purchase price.

As will be appreciated by one of ordinary skill in the art, any number of loyalty campaign configurations may be implanted within the context of the presented embodiments. Moreover, issuance, maintenance, and redemption of loyalty account balances may be managed by any party by way of any known computing hardware components, software systems, network infrastructure, or a combination thereof Moreover, a variety of existing loyalty campaigns may be implemented in conjunction with the disclosed enrollment process without departing from the scope of the invention.

In one embodiment, an enrolled customer, having an established wallet at the loyalty gateway 130, selects a default payment type prior to entering into a payment transaction. As used herein, the “payment type” refers to the transaction instrument, or transaction account, that the customer wishes to execute for a purchase transactions. The payment type may be modified by the customer at the time of transaction confirmation or by the loyalty gateway 130 prior to the customer's confirmation. For example, an enrolled customer may configure his wallet to include information relating to his American Express, Visa, and MasterCard credit cards. Prior to a subsequent purchase, the customer may select the Visa credit card as the “default” transaction instrument. Thereafter, the loyalty gateway 130 will select the Visa transaction instrument information from the remote wallet database 135 in response to receiving transaction information from the merchant POS device 120, even when the customer's American Express credit card was scanned at the merchant POS device 120. Upon confirmation by the customer, information relating to the American Express credit card will be substituted with information relating to the Visa credit card. The transaction information, including the Visa transaction instrument identifier, will be sent from the loyalty gateway 130 to the payment gateway 125.

In accordance with this embodiment; it is feasible that the customer could present a first transaction instrument 115 to a merchant, while the payment gateway 125 executes the purchase transaction using a second transaction device. This significantly eliminates the need for the customer to carry multiple transaction instruments, in that the customer need only to present a single card to merchants, assuming that the transaction instrument has been added to the customer's wallet along with one or more other transaction instruments. The single card may be associated with a plurality of disparate transaction instruments in the customer's wallet; any one of the plurality being selectable to finalize a payment transaction.

Moreover, the enrolled customer may define rules at the loyalty gateway 130 that govern how specific transaction instruments are to be used for payment transactions. Rule parameters are used by the loyalty gateway 130 to determine when a specific rule is to be implemented. For example, a customer may designate his Visa credit card as the default payment type. He may further create a rule that states that when a transaction exceeds $100, the transaction instrument should be switched to his American Express credit card.

Other rules and rule parameters may relate to purchase amount, date of purchase, merchant identifier, merchant type, geographic region, product identifier, purchase type, and the like. In other words, the defined rules and rule parameters govern exactly how and when transaction instruments in the customer's wallet are used. Further, rules may include sub-rules. For example, a rule may state that for any transaction that exceeds $500 for office supplies; 60% of the transaction amount should be authorized against a first transaction instrument, and the remaining balance should be authorized against a second transaction instrument. However, those of ordinary skill in the art will appreciate that any number of rules and rule variances may be defined without departing from the scope of the invention.

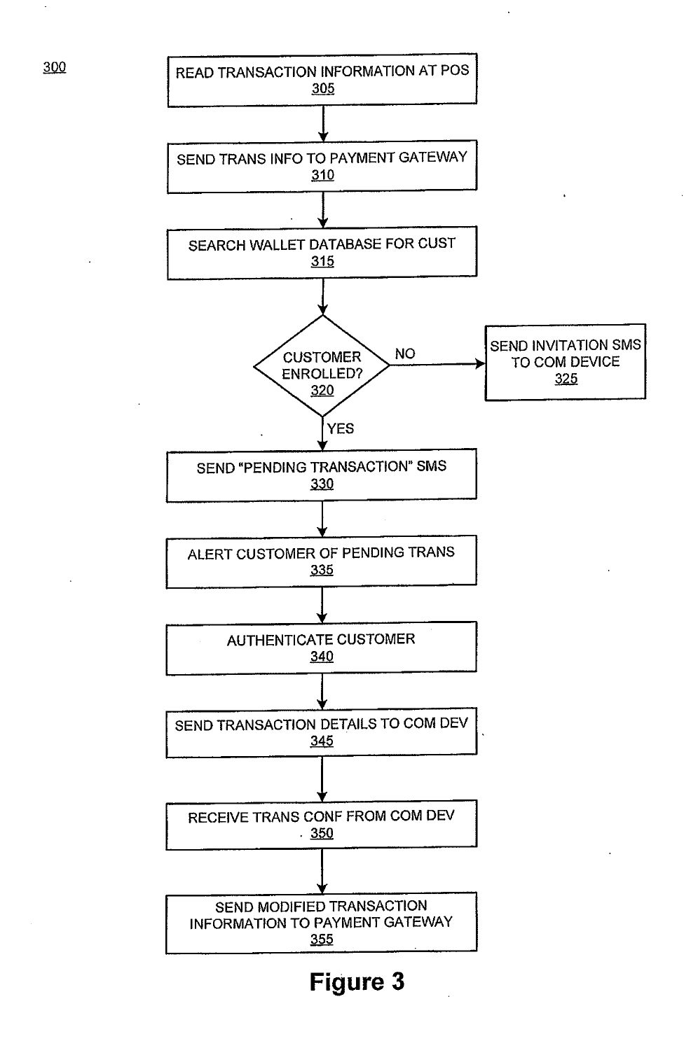

With reference to FIG. 3 and continued reference to FIG. 1, a customer who is enrolled with the loyalty gateway 130 uses their transaction instrument 115 at a merchant POS device 120 to submit payment for a purchase (step 305). The merchant POS device 120 sends transaction information to a payment gateway 125 for transaction authorization (step 310). The transaction information includes data elements that would normally be included in a conventional transaction authorization request. At a minimum, the transaction information includes at least one of a transaction account identifier and/or a MDN that is associated with the customer's communication device 110.

The payment gateway 125 submits the transaction information (or a subset thereof) to the loyalty gateway 130, which performs a search of the remote wallet database 135 for records corresponding to either the MDN, transaction instrument identifier, or both (step 315). If information is returned indicating that the customer has not been enrolled in with the loyalty gateway (step 320), then a SMS message is sent from the loyalty gateway 130 to the communication device 110 inviting the customer to enroll with the loyalty gateway (step 325) in order to establish a wallet. The SMS may optionally include a link to allow the customer to download and install the wallet application 105. Moreover, the SMS may include a coupon code that the customer may redeem toward the current purchase transaction, pending the customer's enrollment with the loyalty gateway 130.

When it has been determined that the customer is enrolled and has established a wallet at the loyalty gateway 130, the loyalty gateway 130 sends a push notification to the communication device 110 (step 330). Upon receipt of the push notification, the wallet application 105 displays an alert notifying the customer of the pending transaction (step 335). In one embodiment, a listener component invokes a visual alert with the number of pending transactions.

The listener component runs as a background process at the communication device 110. The listener component is configured to “listen” for specific events in order to perform a number of functions. For example, the listener component may detect when a push notification is received at the communication device 110 from the loyalty gateway 130. In response, the listener component invokes the communication device 110 to play an audible tone and display a visual alert in accordance with the device's configuration settings in order to notify the customer that a transaction is pending. Further, the listener component may be configured to invoke the wallet application 105 when a defined event is detected such as, for example, when the wallet application 105 has not been fully installed and configured as describe above.

Referring again to FIG. 3, the customer may select a view option from the visual alert and the wallet application 105 is invoked, prompting the customer to enter their PIN (or other authentication credential) (step 340). The wallet application 105 sends the PIN and a device identifier (e.g., a MDN) to the loyalty gateway 130, which acquires personal account information and transaction records from the remote wallet database 135. The acquired information is sent to the communication device 110 and the wallet application 105 presents the customer with a pending transactions interface (step 345). In one embodiment, the pending transactions interface may include information relating to the merchant's name, transaction date/time, transaction amount, and default transaction instrument. The pending transactions interface may further include interface buttons to view transaction details, a detailed disclosure, default payment information, accept transaction, decline transaction, and change payment type.

When the customer views and confirms the transaction and selects an interface button to “accept” the transaction, the communication device 110 sends the confirmation to the loyalty gateway (step 350). The loyalty gateway 130 modifies data in the original authorization request (e.g., modifies the payment type based on the transaction amount), sends the modified authorization request to the payment gateway 125, and updates the customer's records in the remote wallet database 135 to reflect the purchase transaction (step 355). Optionally, the loyalty gateway sends a transaction receipt, or a link to the transaction receipt, to the customer's communication device 110.

The above embodiment may be implemented alone or in combination with the loyalty embodiments presented herein. Practitioners will appreciate that the examples presented are for explanation only and do not limit the scope of the invention in any way. It is also important to note that the associations between records in the remote wallet database 135 may be based on any field or combination of data fields. For example, when a first transaction instrument is scanned at a merchant POS device 120, the transaction instrument identifier may be used to locate an associated second transaction instrument identifier, which is then used to complete the purchase transaction. It is further contemplated that the MDN of the communication device 110 may be used to locate associated remote wallet database records.

Any databases discussed herein may be any type of database, such as relational, hierarchical, graphical, object-oriented, and/or other database configurations. Common database products that may be used to implement the databases include DB2 by IBM (White Plains, N.Y.), various database products available from Oracle Corporation (Redwood Shores, Calif.), Microsoft Access or Microsoft SQL Server by Microsoft Corporation (Redmond, Wash.), or any other suitable database product. Moreover, the databases may be organized in any suitable manner, for example, as data tables or lookup tables. Each record may be a single file, a series of files, a linked series of data fields or any other data structure. Association of certain data may be accomplished through any desired data association technique such as those known or practiced in the art. For example, the association may be accomplished either manually or automatically. Automatic association techniques may include, for example, a database search, a database merge, GREP, AGREP, SQL, and/or the like. The association step may be accomplished by a database merge function, for example, using a “key field” in pre-selected databases or data sectors.

More particularly, a “key field” partitions the database according to the high-level class of objects defined by the key field. For example, certain types of data may be designated as a key field in a plurality of related data tables and the data tables may then be linked on the basis of the type of data in the key field. In this regard, the data corresponding to the key field in each of the linked data tables is preferably the same or of the same type. However, data tables having similar, though not identical, data in the key fields may also be linked by using AGREP, for example. In accordance with one aspect of the present invention, any suitable data storage technique may be utilized to store data without a standard format. Data sets may be stored using any suitable technique, including, for example, storing individual files using an ISO/IEC 7816-4 file structure; implementing a domain whereby a dedicated file is selected that exposes one or more elementary files containing one or more data sets; using data sets stored in individual files using a hierarchical filing system; data sets stored as records in a single file (including compression, SQL accessible, hashed via one or more keys, numeric, alphabetical by first tuple, etc.); block of binary (BLOB); stored as ungrouped data elements encoded using ISO/IEC 7816-6 data elements; stored as ungrouped data elements encoded using ISO/IEC Abstract Syntax Notation (ASN.1) as in ISO/IEC 8824 and 8825; and/or other proprietary techniques that may include fractal compression methods, image compression methods, etc.

In one exemplary embodiment, the ability to store a wide variety of information in different formats is facilitated by storing the information as a Binary Large Object (BLOB). Thus, any binary information may be stored in a storage space associated with a data set. As discussed above, the binary information may be stored on the financial transaction instrument or external to but affiliated with the financial transaction instrument. The BLOB method may store data sets as ungrouped data elements formatted as a block of binary via a fixed memory offset using fixed storage allocation, circular queue techniques, or best practices with respect to memory management (e.g., paged memory, least recently used, etc.). By using BLOB methods, the ability to store various data sets that have different formats facilitates the storage of data associated with the financial transaction instrument by multiple and unrelated owners of the data sets. For example, a first data set which may be stored may be provided by a first issuer, a second data set which may be stored may be provided by an unrelated second issuer, and yet a third data set which may be stored, may be provided by an third issuer unrelated to the first and second issuer. Each of these three exemplary data sets may contain different information that is stored using different data storage formats and/or techniques. Further, each data set may contain subsets of data, which also may be distinct from other subsets.

The data set annotation may be used for various types of status information as well as other purposes. For example, the data set annotation may include security information establishing access levels. The access levels may, for example, be suitably configured to permit only certain individuals, levels of employees, companies, or other entities to access data sets, or to permit access to specific data sets based on the transaction, merchant, issuer, user or the like. Furthermore, the security information may restrict/permit only certain actions such as accessing, modifying, and/or deleting data sets. In one example, the data set annotation indicates that only the data set owner or the user are permitted to delete a data set, various identified merchants are permitted to access the data set for reading, and others are altogether excluded from accessing the data set. However, other access restriction parameters may also be used allowing various entities to access a data set with various permission levels as appropriate.

One skilled in the art will also appreciate that, for security reasons, any databases, systems, devices, servers or other components of the present invention may consist of any combination thereof at a single location or at multiple locations, wherein each database or system includes any of various suitable security features, such as firewalls, access codes, encryption, decryption, compression, decompression, and/or the like.

Furthermore, digital signatures may be employed to provide security and authentication to electronic coupons, electronic receipts or electronic tickets that are provided in association with implementation of the system disclosed herein. In one embodiment, the loyalty gateway 130 may digitally sign electronic coupon data that forms the basis for an electronic coupon. For example, the loyalty gateway 130 applies a hash function to create a hash of the electronic coupon data and applies a private encryption key to the hash to create a digital signature for the electronic coupon data. The loyalty gateway 130 then transmits the electronic coupon data and the corresponding digital signature over the network 140 to the communication device 110. The communication device 110 then utilizes the digital signature to determine the authenticity of the electronic coupon. For example, the wallet application 105 on the communication device 110 applies a corresponding hash function to create a hash of the electronic coupon data it received from the loyalty gateway 130 and applies a public encryption key (corresponding to the private encryption key used by the loyalty gateway 130 to create the digital signature) to the digital signature to determine if the result matches the hash (in which case the digital signature is verified) or does not match the hash (in which case the digital signature is not verified.)

The wallet application 105 may then accept the coupon if the digital signature is verified and reject the coupon if it is not verified. For example, the wallet application 105 maintains a list of coupons available to the customer and will only add to that list an electronic coupon for which the corresponding digital signature has been verified. This provides a basis for the customer to have confidence that any coupon maintained by the wallet application 105 is from a legitimate merchant as it has been confirmed to be authentically from the loyalty gateway 130. It also provides a basis for a merchant that redeems an electronic coupon thereafter to ensure the electronic coupon is legitimate, as the wallet application 105 on the communication device 110 from which the coupon is received would not have previously accepted it otherwise.

One of ordinary skill in the art will recognize other potential applications of digital signatures to electronic coupons or related data in a system such as described herein. For example, when first defining an offer, a merchant may digitally sign associated offer data before transmitting it to the loyalty gateway 130 for use in creating and managing a corresponding electronic coupon, such that verification of the digital signature by the loyalty gateway 130 confirms the authenticity of the offer data as being from the expected merchant. Additionally, after a communication device obtains an electronic coupon from the loyalty gateway 130 as described above and upon initiation by the customer of an operation to redeem the coupon, the wallet application 105 may sign associated data such as a redemption code before transmitting the associated data to the loyalty gateway 130, such that the loyalty gateway 130 can authenticate the coupon as being from a customer authorized to redeem the coupon. Furthermore, upon modifying the corresponding transaction data in accordance with the coupon (for example, reducing the price by 20%) the loyalty gateway 130 may sign the modified transaction data before transmitting it to the payment gateway 125, thereby allowing the payment gateway to confirm the modification is legitimate by verifying the digital signature.

Digital signatures may also be employed to secure and authenticate electronic receipts and related data. For example, the loyalty gateway 130 signs electronic receipt data that forms the basis for an electronic receipt to create a digital signature, and then transmit the electronic receipt data and the digital signature over the network 140 to the communication device 110. The wallet application 105 on the communication device 110 then verifies the signature to confirm the authenticity of the electronic receipt data. This provides a basis for the customer to have confidence that the electronic receipt is legitimate and will be accepted as a proof of purchase or for other purposes requiring authenticity. It also provides a basis for a merchant or other entity who obtains an electronic receipt from a customer via the communication device 110 to ensure the receipt is legitimate, as the wallet application 105 on the communication device 110 would not have previously accepted it otherwise. As another example, the wallet application 105 signs electronic receipt data before transmitting it from the communication device 110 to another entity, so as to authenticate to that entity that the receipt is from the expected customer. It is also noted that the digital receipt may include an offer, such that upon obtaining the receipt the wallet application 105 can redeem the offer much in the same way as an electronic coupon, in which case digital signatures may be utilized in similar fashion and purpose as described above with respect to electronic coupons.

Digital signatures may also be employed to secure and authenticate electronic vouchers such as electronic tickets and related data. For example, the loyalty gateway 130 may digitally sign electronic voucher data that forms a basis for an electronic voucher (such as electronic ticket data that forms the basis for an electronic ticket to an event) to create a digital signature, and then transmit the electronic voucher data (e.g., electronic ticket data) over the network 140 to the communication device 110. The wallet application 105 may then verify the digital signature to confirm the authenticity of the electronic voucher data (e.g., electronic ticket data.) This provides a basis for the customer to have confidence that any electronic voucher received is a legitimate voucher that will be accepted (such as a legitimate ticket that will gain acceptance to an event.) It also provides a basis for an entity that accepts the voucher (such as a ticket taker at an event) to ensure it is legitimate, as the wallet application 105 on the communication device 110 from which the voucher is received would not have previously accepted it otherwise.

In one possible implementation of various embodiments of the invention, digital signature functions performed by a mobile communication device such as communication device 110 may employ a Network Access and Credential Verification module that combines features of a Subscriber Identity Module (SIM) with a personal token card such as Common Access Card (CAC) or Personal Identify Verification (PIV) card. Such a module is described in U.S. patent application Ser. No. 12/910,611, entitled “System and Device for Consolidating SIM, Personal Token and Associated Applications” and filed on Oct. 22, 2010. Implementation of such a module in an electronic wallet application is further described in U.S. patent application Ser. No. 12/982,271, entitled “System and Device for Consolidating SIM, Personal Token and Associated Applications for Electronic Wallet Transactions” and filed on Dec. 30, 2010.

The present invention may be described herein in terms of functional block components, optional selections and/or various processing steps. It should be appreciated that such functional blocks may be realized by any number of hardware and/or software components suitably configured to perform the specified functions. For example, the present invention may employ various integrated circuit components, e.g., memory elements, processing elements, logic elements, look-up tables, and/or the like, which may carry out a variety of functions under the control of one or more microprocessors or other control devices. Similarly, the software elements of the present invention may be implemented with any programming or scripting language such as C, C++, Java, COBOL, assembler, PERL, Visual Basic, SQL Stored Procedures, extensible markup language (XML), Microsoft.Net with the various algorithms being implemented with any combination of data structures, objects, processes, routines or other programming elements. Further, it should be noted that the present invention may employ any number of conventional techniques for data transmission, messaging, data processing, network control, and/or the like. Still further, the invention could be used to detect or prevent security issues with a client-side scripting language, such as JavaScript, VBScript or the like. For a basic introduction of cryptography and network security, the following may be helpful references: (1) “Applied Cryptography: Protocols, Algorithms, And Source Code In C,” by Bruce Schneier, published by John Wiley & Sons (second edition, 1996); (2) “Java Cryptography” by Jonathan Knudson, published by O'Reilly & Associates (1998); (3) “Cryptography & Network Security: Principles & Practice” by Mayiam Stalling, published by Prentice Hall; all of which are hereby incorporated by reference.

It should be appreciated that the particular implementations shown and described herein are illustrative of the invention and its best mode and are not intended to otherwise limit the scope of the present invention in any way. Indeed, for the sake of brevity, conventional data networking, application development and other functional aspects of the systems (and components of the individual operating components of the systems) may not be described in detail herein. It should be noted that many alternative or additional functional relationships or physical connections might be present in a practical transaction instrument distribution system.

Furthermore, while the invention has been described in the context of a loyalty wallet environment, it should be understood that some described features may be applicable and novel in a general payment wallet environment and, as such, the present specification may support inventions not necessarily limited to a loyalty wallet environment. In such case, for example, relevant functions may be performed by a wallet gateway (or wallet component of the payment gateway 125) instead of the loyalty gateway 130 shown herein.

As may be appreciated by one of ordinary skill in the art, the present invention may be embodied as a method, a data processing system, a device for data processing, a financial transaction instrument, and/or a computer program product. Accordingly, the present invention may take the form of an entirely software embodiment, an entirely hardware embodiment, or an embodiment combining aspects of both software and hardware or other physical devices. Furthermore, the present invention may take the form of a computer program product on a tangible computer-readable storage medium having computer-readable program code means embodied in the storage medium. Any suitable tangible computer-readable storage medium may be utilized, including hard disks, CD-ROM, optical storage devices, magnetic storage devices, and/or the like.

These computer program instructions may also be stored in a computer-readable memory that may direct a computer or other programmable data processing apparatus to function in a particular manner, such that the instructions stored in the computer-readable memory produce an article of manufacture including instruction means which implement functions of flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus include steps for implementing the functions specified in the flowchart block or blocks.

In the foregoing specification, the invention has been described with reference to specific embodiments. However, it may be appreciated that various modifications and changes may be made without departing from the scope of the present invention. The specification and figures are to be regarded in an illustrative manner, rather than a restrictive one, and all such modifications are intended to be included within the scope of present invention. Accordingly, the scope of the invention should be determined by the appended claims and their legal equivalents, rather than by the examples given above. For example, the steps recited in any of the method or process claims may be executed in any order and are not limited to the order presented.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as critical, required, or essential features or elements of any or all the claims. As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus. Further, no element described herein is required for the practice of the invention unless expressly described as “essential” or “critical”.

1. A system for authenticating a transaction instrument utilized by a customer in a loyalty program, the system comprising:
a loyalty gateway creating a digital signature based on transaction instrument data associated with the transaction instrument;
a network over which the digital signature and transaction instrument data are provided by the loyalty gateway; and
a computing device of the customer receiving the digital signature and transaction instrument data over the network and verifying the digital signature to confirm authenticity of the transaction instrument data.

2. The system of claim 1 wherein
the loyalty gateway creates the digital signature based on electronic coupon data associated with an electronic coupon, and
the computing device verifies the digital signature to confirm authenticity of the electronic coupon data.

3. The system of claim 1 wherein
the loyalty gateway creates the digital signature based on electronic receipt data associated with an electronic receipt, and
the computing device verifies the digital signature to confirm authenticity of the electronic receipt data.

4. The system of claim 1 wherein
the loyalty gateway creates the digital signature based on electronic ticket data associated with an electronic ticket, and
the computing device verifies the digital signature to confirm authenticity of the electronic ticket data.

5. The system of claim 1 wherein the computing device includes an electronic wallet software application that accepts the transaction instrument if the digital signature is verified and rejects the transaction instrument if the digital signature is not verified.

6. The system of claim 1 wherein the computing device is a mobile communication device of the customer.

7. A system for authenticating a transaction instrument utilized by a customer in a transaction, the system comprising:
a transaction gateway creating a digital signature based on transaction instrument data associated with the transaction instrument;
a network over which the digital signature and transaction instrument data are provided by the transaction gateway; and
a mobile communication device of the customer receiving the digital signature and transaction instrument data over the network and verifying the digital signature to confirm authenticity of the transaction instrument data.

8. The system of claim 7 wherein
the transaction gateway creates the digital signature based on electronic coupon data associated with an electronic coupon, and
the mobile communication device verifies the digital signature to confirm authenticity of the electronic coupon data.

9. The system of claim 7 wherein
the transaction gateway creates the digital signature based on electronic receipt data associated with an electronic receipt, and
the mobile communication device verifies the digital signature to confirm authenticity of the electronic receipt data.

10. The system of claim 7 wherein
the transaction gateway creates the digital signature based on electronic ticket data associated with an electronic ticket, and
the mobile communication device verifies the digital signature to confirm authenticity of the electronic ticket data.

11. The system of claim 7 wherein the mobile communication device includes an electronic wallet software application that accepts the transaction instrument if the digital signature is verified and rejects the transaction instrument if the digital signature is not verified.

12. A method for authenticating a transaction instrument utilized by a customer in a loyalty program, the method performed by a computer system and comprising the steps of:
creating a digital signature based on transaction instrument data associated with the transaction instrument; and
providing the digital signature and the transaction instrument data over a network to a computing device having a loyalty wallet software application that verifies the digital signature to confirm the authenticity of the transaction instrument data.

13. The method of claim 12 wherein
the step of creating the digital signature comprises creating the digital signature based on electronic coupon data associated with an electronic coupon, and
the step of providing the digital signature and the transaction instrument data comprises providing the digital signature and the transaction instrument data to a computing device that verifies the digital signature to confirm authenticity of the electronic coupon data.

14. The method of claim 12 wherein
the step of creating the digital signature comprises creating the digital signature based on electronic receipt data associated with an electronic receipt, and
the step of providing the digital signature and the transaction instrument data comprises providing the digital signature and the transaction instrument data to a computing device that verifies the digital signature to confirm authenticity of the electronic receipt data.

15. The method of claim 12 wherein
the step of creating the digital signature comprises creating the digital signature based on electronic ticket data associated with an electronic ticket, and
the step of providing the digital signature and the transaction instrument data comprises providing the digital signature and the transaction instrument data to a computing device that verifies the digital signature to confirm authenticity of the electronic ticket data.

16. The method of claim 12, further comprising the step of obtaining indicia from the computing device that the digital signature was verified by the loyalty wallet software application to confirm legitimacy of the transaction instrument.

17. A method for authenticating a transaction instrument utilized by a customer in a transaction, the method performed by a computer system and comprising the steps of:
creating a digital signature based on transaction instrument data associated with the transaction instrument; and
providing the digital signature and the transaction instrument data over a network to a mobile communication device that verifies the digital signature to confirm authenticity of the transaction instrument data.

18. The method of claim 17 wherein
the step of creating the digital signature comprises creating the digital signature based on electronic coupon data associated with an electronic coupon, and
the step of providing the digital signature and the transaction instrument data comprises providing the digital signature and the transaction instrument data to a mobile communication device that verifies the digital signature to confirm authenticity of the electronic coupon data.

19. The method of claim 17 wherein
the step of creating the digital signature comprises creating the digital signature based on electronic receipt data associated with an electronic receipt, and
the step of providing the digital signature and the transaction instrument data comprises providing the digital signature and the transaction instrument data to a mobile communication device that verifies the digital signature to confirm the authenticity of the electronic receipt data.

20. The method of claim 17 wherein
the step of creating the digital signature comprises creating the digital signature based on electronic ticket data associated with an electronic ticket, and
the step of providing the digital signature and the transaction instrument data comprises providing the digital signature and the transaction instrument data to a mobile communication device that verifies the digital signature to confirm authenticity of the electronic ticket data.

21. A method of authenticating a transaction instrument utilized by a customer in a transaction, the method performed by a mobile communication device and comprising the steps of:
obtaining, from a transaction gateway, transaction instrument data associated with the transaction instrument;
obtaining from the transaction gateway a digital signature based on the transaction instrument data; and
verifying the digital signature to confirm authenticity of the transaction instrument data.

22. The method of claim 21 wherein
the step of obtaining the transaction instrument data comprises obtaining electronic coupon data associated with an electronic coupon, and
the step of obtaining the digital signature comprises obtaining a digital signature based on the electronic coupon data.

23. The method of claim 21 wherein
the step of obtaining the transaction instrument data comprises obtaining electronic receipt data associated with an electronic receipt, and
the step of obtaining the digital signature comprises obtaining a digital signature based on the electronic receipt data.

24. The method of claim 21 wherein
the step of obtaining the transaction instrument data comprises obtaining electronic ticket data associated with an electronic ticket, and
the step of obtaining the digital signature comprises obtaining a digital signature based on the electronic ticket data.

25. The method of claim 21, further comprising the step of executing an electronic wallet software application that accepts the transaction instrument if the digital signature is verified and rejects the transaction instrument if the digital signature is not verified.
